(19) United States
(12) Patent Application Publication
(10) Pub. No.: US 2012/0024125 A1
(43) Pub. Date: Feb. 2, 2012

(54) LOOP CUTTER KNIFE FIXTURE WITH REPLACEABLE BLADES

(75) Inventors: David B. Walker, Meridian, ID (US); Allen J. Neel, Nampa, ID (US)

(73) Assignee: J.R. SIMPLOT COMPANY, Boise, ID (US)

(21) Appl. No.: 13/181,446

(22) Filed: Jul. 12, 2011

Related U.S. Application Data
(60) Provisional application No. 61/369,220, filed on Jul. 30, 2010.

(51) Int. Cl. B26D 1/29; B26D 7/06

(52) U.S. Cl. 83/402; 83/676

(57) ABSTRACT

A loop cutter knife fixture for cutting vegetable products such as raw potatoes into spiral or helical loops. The knife fixture includes a circular blade holder adapted to be rotatably driven within a vegetable product flow path. The blade holder includes a central core cutter in combination with a spiral base plate defining a radial slot between axially spaced upstream and downstream ends thereof. Small slits are formed in this base plate for seated reception of preferably multiple U-shaped strip blades, which are in turn overlaid and clamped in place beneath a generally pie-shaped slab blade having a sharpened knife edge exposed at the base plate radial slot and held in place by preferably multiple clamp screws. The strip blades and/or the slab blade are formed from an inexpensive material, such as sheet metal or the like, whereby blade changeover is quick and economical.

### BACKGROUND OF THE INVENTION

This invention relates generally to improvements in devices and methods for cutting food products such as vegetable products, and particularly such as raw potatoes and the like, into spiral or helical shaped pieces. More particularly, this invention relates to a rotatably driven knife fixture having relatively inexpensive and easily changed cutting blades.

Production cutting systems and related knife fixtures are generally well known in the art for cutting vegetable products such as raw potatoes into spiral or helical shaped pieces, preparatory to further production processing steps such as blanching and parfrying. In this regard, one typical production system comprises an hydraulic cutting system wherein a so-called water knife fixture is mounted along the length of an elongated tubular conduit. A pumping device is provided to entrain the vegetable product such as raw potatoes within a propelling water flume for cutting engagement with knife blades of the water knife fixture. The vegetable product is pumped one at a time in single file succession into and through the water conduit with a velocity and sufficient kinetic energy to carry the vegetable product through a relatively complex knife fixture which includes rotary cutting blades, including slab and strip blades, to sever the product into a plurality of smaller pieces of generally spiral or helical shape. The cut pieces are then carried further through a discharge conduit for appropriate subsequent processing, including cooking or blanching, parfrying, freezing and packaging steps, for subsequent finish processing and serving to customers as loops, twirls, curly fries, etc.

Examples of such hydraulic cutting systems and related rotary knife fixtures are found in U.S. Pat. Nos. 5,168,784; 5,179,881; 5,277,546; 5,343,791; 5,394,780; 5,394,793; 5,473,967; 5,992,287; and Re. 38,149, all of which are incorporated by reference herein. Persons skilled in the art will recognize and appreciate that mechanical production feed systems may be employed in lieu of hydraulic feed systems, as described in U.S. Pat. Nos. 5,097,735; 5,167,177; 5,167,178; and 5,293,803, which are also incorporated by reference herein.

One common problem associated with rotary knife fixtures designed to cut potatoes and the like into spiral or helical pieces relates to the need for periodic re-sharpening of the slab and strip blades. In many cases, the knife fixture is formed with a unitary construction to provide a robust or sturdy component that can survive a production environment for several years. However, the knife fixture must be periodically removed and the blades thereof re-sharpened to maintain production cut quality over an extended period of time. Typically, the entire knife fixture is removed and replaced by another knife fixture with sharpened slab and strip knives, while the slab and strip knives of the removed knife fixture are re-sharpened. This knife fixture changeover process is relatively costly, since it is necessary to remove the entire knife fixture from the cutting apparatus, and to maintain multiple and relatively expensive spare knife fixtures with re-sharpened slab and strip knives in order to maintain several parallel cutting lines in production service.

The present invention is directed to an improved rotary knife fixture of the type used to cut a raw vegetable product such as a potato into spiral or helical shaped strips, wherein the slab and strip knives are conveniently formed from an inexpensive material such as sheet metal or the like, and are adapted for quick and easy disassembly from the knife fixture for re-sharpening, and for similar quick and easy assembly of a re-sharpened set of cost-efficient slab and strip knives with the knife fixture for resumed production. As a result, it is necessary only to maintain spare re-sharpened slab and strip knives for quick and easy assembly with the knife fixture.

### SUMMARY OF THE INVENTION

In accordance with the invention, a rotary knife fixture is provided for cutting vegetable products such as raw potatoes into spiral or helical loops, wherein the rotary knife fixture includes a blade holder supporting separately mounted slab and strip knife blades formed conveniently from a relatively inexpensive material, such as sheet metal or the like.

The rotary knife fixture includes a circular blade holder adapted to be rotatably driven within a vegetable product flow path, such as along an hydraulic flow conduit. The blade holder includes a cylindrical central core cutter in combination with a spiral base plate defining a radial slot between axially spaced upstream and downstream ends thereof. Small slits are formed in this blade holder for seated reception of preferably multiple U-shaped strip blades, which are in turn overlaid by a generally pie-shaped slab blade having a sharpened knife edge exposed at the radial slot of the blade holder. This slab blade is clamped onto the blade holder at an inner end thereof by seating within a radially open notch formed in the central core cutter, and at an outer end thereof by preferably multiple clamp screws.

The slab and strip knife blades are thus carried by the blade holder for rotation in the production flow path to cut respectively a generally helical slab from each vegetable product and then to split that slab into multiple helical loops of different diametric sizes which are discharged for further processing. When the slab and/or strip blades require re-sharpening, the cost-efficient slab and strip blades are disassembled quickly and easily from the blade holder, and replaced by similar new or re-sharpened slab and strip blades for resumed production.

In one preferred form of the invention when the knife fixture in used in an hydraulic cutting system, the blade holder additionally has at least one and preferably multiple open passages formed therein to accommodate relatively unrestricted flow of the hydraulic fluid, such as water, therethrough without requiring fluid bypass of the knife fixture. These open passages may take the form of axially open slots formed in the blade holder, with each slot preferably formed on a common radius.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a schematic diagram depicting an hydraulic cutting system of a type utilizing a rotatably driven knife fixture constructed in accordance with the present invention;

FIG. 2 is an enlarged perspective view illustrating a drive motor and cog belt for rotatably driving the knife fixture of FIG. 1;

FIG. 3 is an exploded perspective view showing rotatable mounting of the knife fixture within a rotary bearing unit;

FIG. 4 is a front side perspective view of the knife fixture;

FIG. 5 is an exploded perspective view of the knife fixture of FIG. 4; and

FIG. 6 is a rear side perspective view of the knife fixture.

### DETAILED DESCRIPTION OF THE PREFERRED EMBODIMENTS

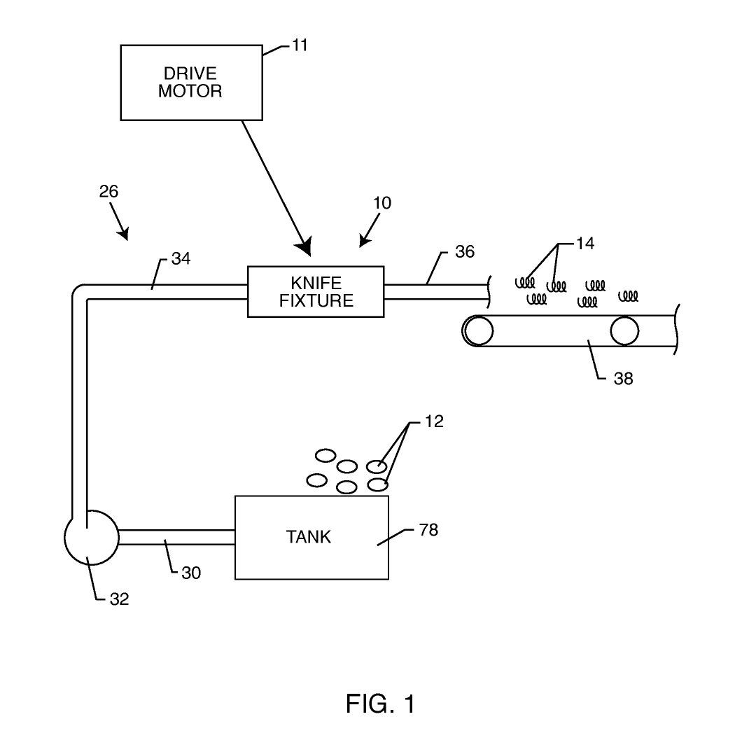

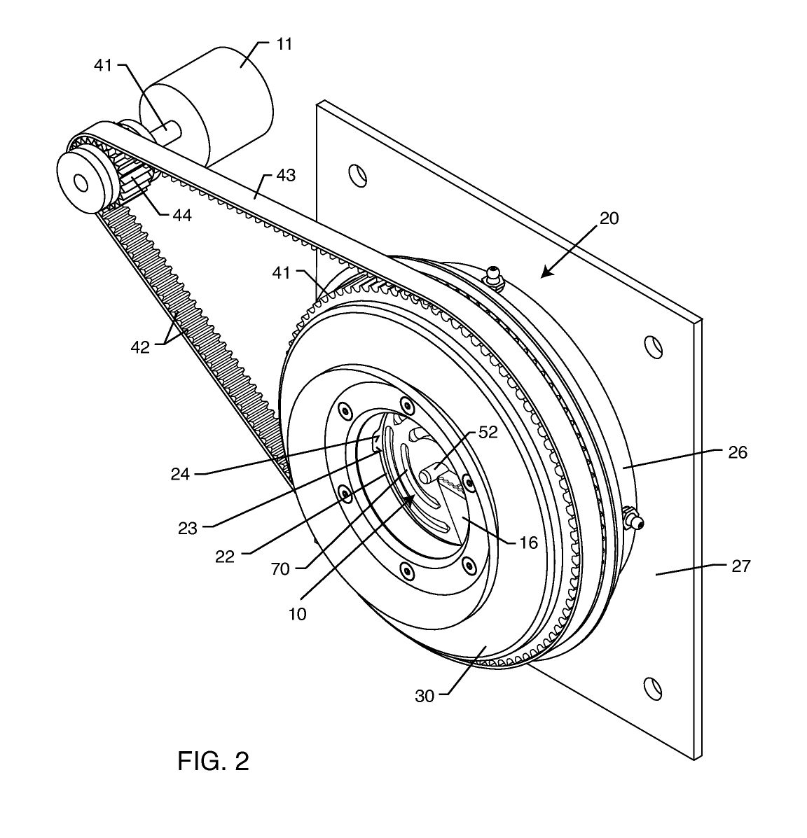

As shown in the exemplary drawings, an hydraulic cutting system comprises a conventional so-called water knife fixture referred to generally in FIG. 1 by the reference numeral 10 for cutting vegetable products such as whole potatoes 12 into spiral or helical shaped strips 14 for subsequent processing. The present invention comprises a rotary driven knife fixture 10 (FIGS. 2-6) for installation into the cutting system and for rotatable driving by means of a drive motor 11 or the like. The knife fixture 10 includes a relatively inexpensive or cost-efficient slab blade 16 in combination with at least one and preferably multiple strip blades 18 adapted for relatively quick and easy disassembly from the knife fixture 10 when blade re-sharpening is required, and for similarly quick and easy assembly of new or re-sharpened blades 16, 18 with the knife fixture 10 for resumed production.

FIG. 1 shows the cutting system in the form of an hydraulic cutting system comprising a tank 78 or the like for receiving a supply of vegetable products, such as the illustrative raw whole potatoes 12 in a peeled or unpeeled state. These potatoes 12 are delivered via an inlet conduit 30 to a pump 32 which propels the potatoes in single file relation within a propelling water stream or flume through a tubular delivery conduit 34 into cutting engagement with the blades (not shown in FIG. 1) of the water knife fixture 10. In a typical hydraulic cutting system, the potatoes are propelled through the delivery conduit 34 at a relatively high velocity of about 40-60 feet per second to provide sufficient kinetic energy whereby each potato is propelled through the knife fixture 10 to produce (as will be described in more detail herein) the desired elongated spiral or helical cut strips 14. In this regard, the delivery conduit 34 may include a centering alignment device (not shown) for substantially centering each potato 12 on a longitudinal centerline of the flow passage extending through the associated knife fixture 10, in a manner known to persons skilled in the art. The cut strips 14 travel through a short discharge conduit 36 to a conveyor 38 or the like which transports the cut strips 14 for further processing, such as blanching, drying, batter coating, parfrying, freezing, etc.

Persons skilled in the art will recognize and appreciate that alternative form cutting systems may be used, to include, by way of example, mechanical cutting systems wherein the vegetable products such as potatoes are mechanically delivered via a chute or hopper or the like to the knife fixture 10. In either case, the knife fixture 10 is mounted along a production path and is rotatably driven for engaging and cutting the incoming products into the desired spiral or helical shaped strips.

The present invention recognizes that periodic re-sharpening of the cutting blades of the knife fixture 10 is required to maintain production cut quality over an extended period of time. In accordance with the invention, the slab and strips blades 16, 18 of the knife fixture 10 are formed from a relatively inexpensive or cost-efficient material, such as sheet metal or the like, and are adapted for quick and easy disassembly from and similarly quick and easy clamp-on assembly with the remaining components of the knife fixture 10. Accordingly, comparatively dull slab and strip blades 16, 18 can be removed quickly and easily, when required, and replaced by new or re-sharpened slab and strip blades 16, 18 in a similarly quick and easy manner. This enables production to continue with minimal interruption for blade change-over. In addition, there is no requirement for obtaining and/or maintaining multiple and relatively costly spare knife fixtures. Instead, it is only required to obtain and/or maintain multiple sets of the comparatively inexpensive slab and strip blades 16, 18.

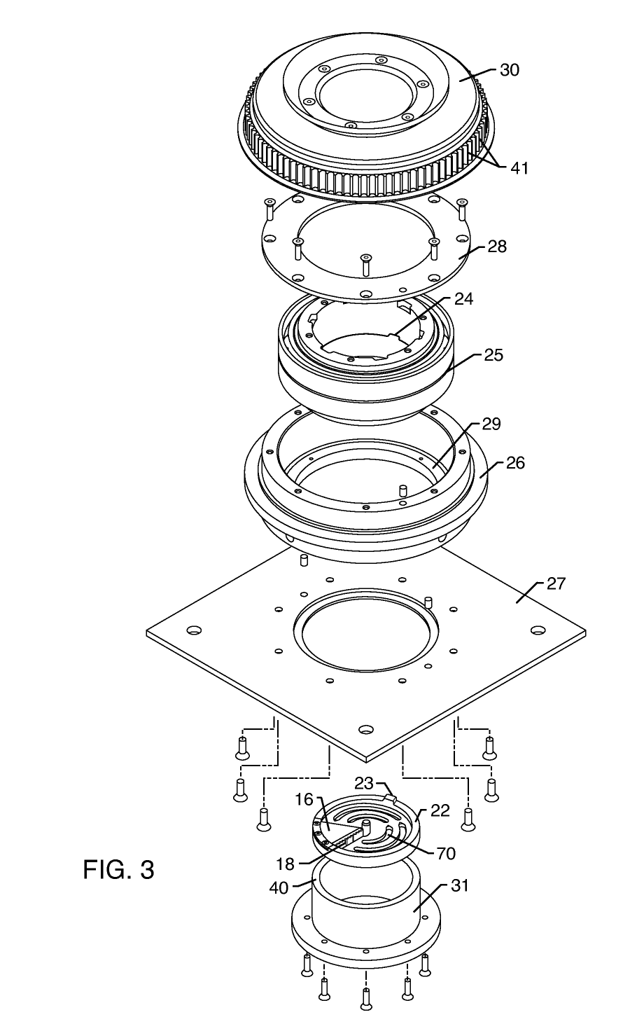

FIGS. 2-3 show installation of the illustrative knife fixture 10 into a rotary bearing unit 20 is a position in-line with a production path for the vegetables such as the potatoes 12 (FIG. 1). In this regard, the illustrative knife fixture 10 comprises a blade holder including an outer support ring 22 of generally circular shape, and having cross sectional area sufficient for providing a relatively stiff or sturdy structure capable of withstanding the rigors of a production environment over an extended period of time. This outer ring 22 includes a upstanding or forwardly projecting drive tab 23 having a size and shape to fit within a matingly shaped drive notch 24 formed in a rotatable bearing housing 25.

As shown in FIG. 3, the bearing housing is rotatably carried within a bushing 26 carried on an enlarged plate 27 adapted for in-line installation along the production path. A flange plate 28 overlies the bearing housing 25 for sandwiching the housing 25 against an internal shoulder 29 within the bushing 26. A driven ring 30 is mounted in turn onto the bearing housing 25 for rotation therewith. A rear-side bushing 31 is adapted for secure mounting onto a rear or aft side of the enlarged plate 27, and includes a forwardly presented shoulder 40 for rotatably supporting and retaining the outer support ring 22 of the knife fixture 10 in place, during cutting operation.

The driven ring 30 of the rotary bearing unit 20 includes a circumferential array of detents 41 for registry with teeth 42 of a cog-type drive belt 43. This drive belt 43 is in turn reeved about a drive gear 44 on an output shaft 45 of the drive motor 11 (FIG. 2). Accordingly, the drive motor 11 positively drives the driven ring 30 and associated bearing housing 25 secured thereto at a known speed, preferably on the order of about 6,000 rpm in the case of the illustrative hydraulic cutting system, for correspondingly rotatably driving the knife fixture 10 by means of the inter-engaged tab 23 and notch 24. Importantly, the cog-type drive belt 43 beneficially insures constant-speed rotatable driving of the knife fixture 10 notwithstanding periodic impact engagement of the water-propelled potatoes therewith.

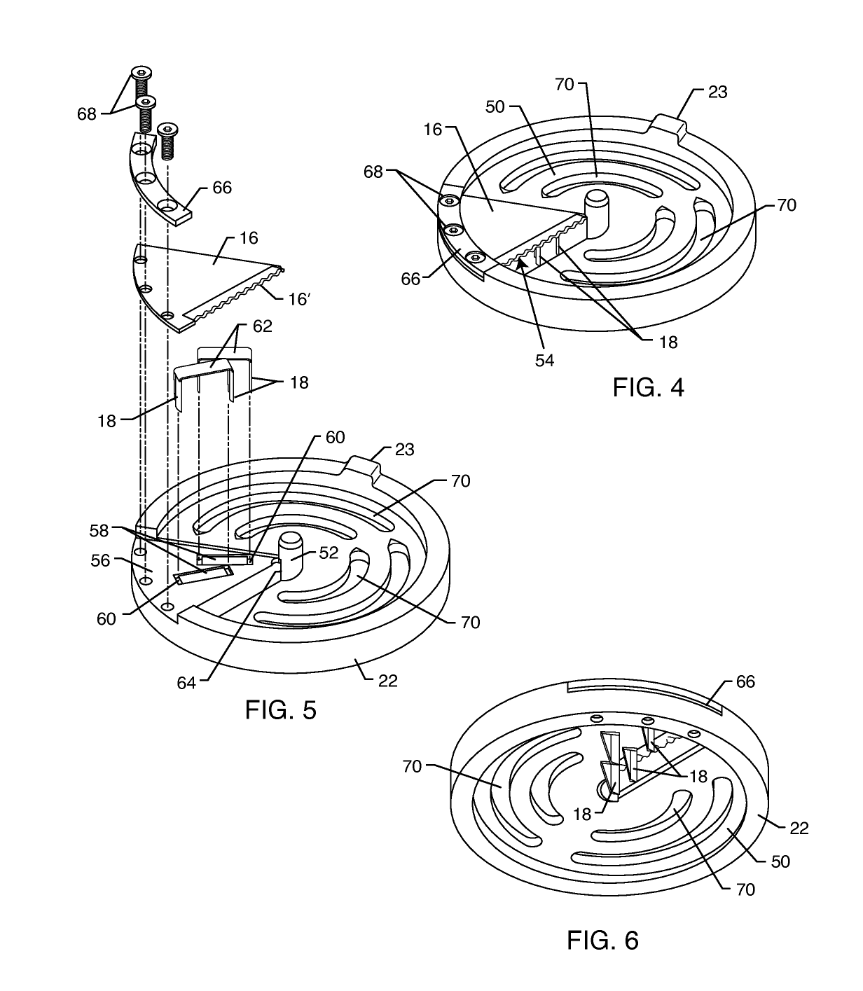

The blade holder of the knife fixture 10 further comprises a base plate 50 extending radially inwardly from the outer support ring 22, and terminating at a generally centrally positioned tubular core cutter 52 having a sharpened knife edge 53 formed at a front or upstream end thereof. Importantly, this base plate 50 has a generally spiral or helical shape wherein an upstream end or leading edge thereof is spaced axially about ¼ inch from a downstream end or trailing edge thereof, thereby defining a radially open slot 54 between these axially spaced leading and trailing edges. In other words, the base plate 50 is formed to extend generally spirally through one turn between these axially spaced leading and trailing edges defining the radial slot 54 (FIG. 4).

A generally pie-shaped region, shown in the illustrative drawings to occupy an arcuate span of about 60 of the base plate 50 comprises a shallow recess 56 formed therein at a position adjacent the leading edge of the base plate 50 defining the radial slot 54 (FIG. 4). In turn, within this shallow recess 56, there is at least one and preferably multiple shallow recessed seats 58 of generally rectangular shape, the opposite ends of which include relatively small slits 60 formed to extend generally perpendicular to a radius of the base plate 50.

At least one and preferably multiple, generally U-shaped strip blades 18 are provided to extend downwardly through the small slits 60 in the base plate 50, wherein each pair of these strip blades is preferably interconnected by a short, generally rectangular bight or base piece 62. As shown best in FIG. 5, the illustrative drawings show two bights 62 sized and shaped for nested respective reception into the pair of recessed seats 60, with the opposite ends of the two bights or base pieces 62 being integrally joined with an associated pair of strip blades 18 which extend downwardly through slits 60 and a short distance beyond the base plate 50 (FIG. 6). Each of these multiple strip blades 18 includes an axially extending sharpened edge presented in a direction toward the adjacent slot 54.

The installed pair of bights 62 each coupled to an associated pair of the strip blades 18 are suitably and easily clamped in-place onto the base plate 50 by the overlying clamp plate including the slab blade 16. As shown best in FIGS. 4-5, this clamp plate 16 has a generally pie-shaped configuration for nested reception into the shallow pie-shaped recess 56 on the base plate 50, with a radially inner end retained within a radially open notch 64 formed in the side of the core cutter 52, and with a radially outer end clamped securely onto the outer support ring 22 by means of an arcuate clamp segment 66 and at least one and preferably multiple mounting screws 68. In this clamped position, the clamp plate defines the slab blade having a relatively sharp cutting edge 16′ exposed at the radially open slot 54 by projecting circumferentially a short distance beyond the underlying leading edge of the base plate 50.

In operation, the knife fixture 10 is mounted along the product production flow path and is rotatably driven by the drive motor 11 at a speed and torque sufficient to cut each incoming potato 12 or the like into the desired spiral or helical shaped pieces 14. The slab blade 16 initially engaging and cuts each incoming product into a spiral slab, whereby the trailing strip knives 18 in turn separate this spiral slab into multiple spiral or helical strip-shaped pieces 14. With four of the strip blades 18 as shown, persons skilled in the art will appreciate that each incoming potato 12 or the like is cut into as many as five spiral pieces of different diametric size. The core cutter, of course, cuts a straight and generally centered strip of round cross sectional shape from each incoming potato 12.

When blade removal for re-sharpening is indicated, the knife fixture 10 is removed from the rotary bearing unit 20 for quick and easy removal of the slab and strip knives 16, 18. Removal from the rotary bearing unit 20 is accomplished quickly and easily by slide-out removal of the rear-side bushing 31 (FIG. 2). Then, the arcuate clamp segment 66 (FIGS. 4-5) is quickly and easily removed to permit lift-off removal of the clamp plate with the slab blade 16, thereby exposing the underlying bights or base pieces 62 carrying the strip knives 18. The strip knives 18 are easily lifted from the base plate 50 and removed from the base plate 50, together with the slab blade 16, for re-sharpening. Importantly, during this blade sharpening interval, the knife fixture 10 may be placed back into production service by installing a new or previously re-sharpened set of slab and strip blades 16, 18 onto the base plate 50 of the knife fixture 10 followed by replacement of the re-assembled knife fixture 10 into the rotary bearing unit 20.

In accordance with one alternative preferred form of the invention, the knife fixture 10 may be adapted particularly for use in an hydraulic cutting system without requiring bypass flow of a propelling fluid such as water. In this regard, FIGS. 2-6 show the base plate 50 of the knife fixture 10 to include multiple axial flow openings 70 each formed preferably on a common radius. These flow openings 70 beneficially accommodate through-flow of a propelling fluid stream in an hydraulic cutting system as shown, without requiring any fluid bypass flow arrangement.

A variety of modifications and improvements in and to the rotary knife fixture 10 of the present invention will be apparent to those persons skilled in the art. Accordingly, no limitation on the invention is intended by way of the foregoing description and accompanying drawings, except as set forth in the appended claims.

What is claimed is:

1. A rotary knife fixture for cutting vegetable products into spiral loops, said knife fixture comprising:
a generally spiral-shaped blade holder for mounting along a vegetable product flow path and having at least one radial slot formed therein between axially spaced upstream and downstream ends thereof, and at least one slit formed in said blade holder to extend generally perpendicular to said at least one radial slot;
at least one strip blade mounted onto said blade holder and extending through said at least one slit;
at least one slab blade mounted onto said blade holder over said strip blade and having a radially extending cutting edge exposed at said at least one radial slot at said upstream end thereof; and
a clamp plate mounted onto said blade holder over said at least one slab blade for clamping said at least one slab blade and said at least one strip blade removably onto said blade holder;
whereby upon rotational driving of said blade holder within the vegetable product flow path with said at least one slab blade and said plurality of strip blades mounted thereon, said at least one slab blade cuts the vegetable products into generally spiral loops and said at least one strip blade cuts said spiral loops into elongated spiral strips of different diametric sizes; and
further whereby said at least one slab blade and said at least one strip blade are removable from said blade holder for sharpening.

2. The rotary knife fixture of claim 1 further including means for rotatably driving said blade holder within the vegetable product flow path.

3. The rotary knife fixture of claim 1 wherein said at least one slit formed in said blade holder comprises a pair of said slits formed in radially spaced relation, and further wherein said at least one strip blade comprises a pair of said strip blades interconnected by a base piece to form a generally U-shaped construction with said pair of strip blades being receivable through said pair of slits.

4. The rotary knife fixture of claim 1 wherein said blade holder includes a generally cylindrical core cutter, said at least one radial slot and said at least one slit being formed in a base plate of said blade holder.

5. The rotary knife fixture of claim 2 wherein said blade holder has a generally circular shape in includes an axially projecting tab formed near the periphery thereof for mating driven engagement within a notch formed in said means for rotatably driving said blade holder.

6. The rotary knife fixture of claim 1 wherein said upstream and downstream ends of said spiral-shaped blade holder are disposed axially about ¼ inch from each other to define said at least one radial slot.

7. The rotary knife fixture of claim 1 wherein said blade holder has a shallow recess formed therein generally at an upstream side thereof, said at least one slab blade having a size and shape for seated reception within said shallow recess.

8. The rotary knife fixture of claim 7 wherein said at least one slit formed in said blade holder comprises a pair of said slits formed in radially spaced relation, and further wherein said at least one strip blade comprises a pair of said strip blades interconnected by a base piece to form a generally U-shaped construction with said pair of strip blades being receivable through said pair of slits, and further wherein said blade holder further comprises at least one shallow seat formed therein at opposite ends of said pair of slits for seated reception of said base piece.

9. The rotary knife fixture of claim 8 wherein said pair of slits formed in said blade holder comprises multiple pairs of said slits, each of said pair of said slits being separated by a shallow seat for seated reception of one of said base pieces interconnecting a pair of said strip blades.

10. The rotary knife fixture of claim 1 wherein said clamp plate comprises an arcuate segment secured to said blade holder by at least one clamp screw.

11. The rotary knife fixture of claim 1 wherein said blade holder further comprises at least one axial flow opening formed therein for through passage of water.

12. The rotary knife fixture of claim 1 wherein the vegetable products comprise potatoes.

13. A rotary knife fixture for cutting vegetable products into spiral loops, said knife fixture comprising:
a generally spiral-shaped blade holder mounted along a vegetable product flow path and having at least one radial slot formed therein between axially spaced upstream and downstream ends thereof, and at least one slit formed in said blade holder to extend generally perpendicular to said at least one radial slot;
at least one strip blade mounted onto said blade holder and extending through said at least one slit;
at least one slab blade mounted onto said blade holder over said strip blade and having a radially extending cutting edge exposed at said at least one radial slot at said upstream end thereof;
a clamp plate mounted onto said blade holder over said at least one slab blade for clamping said at least one slab blade and said at least one strip blade removably onto said blade holder; and
means for rotatably driving said blade holder with said at least one slab blade and said at least one strip blade mounted thereon within the vegetable product flow path;
whereby said at least one slab blade cuts the vegetable products into generally spiral loops and said at least one strip blade cuts said spiral loops into elongated spiral strips of different diametric sizes; and
further whereby said at least one slab blade and said at least one strip blade are removable from said blade holder for sharpening.

14. The rotary knife fixture of claim 13 wherein said at least one slit formed in said blade holder comprises a pair of said slits formed in radially spaced relation, and further wherein said at least one strip blade comprises a pair of said strip blades interconnected by a base piece to form a generally U-shaped construction with said pair of strip blades being receivable through said pair of slits.

15. The rotary knife fixture of claim 13 wherein said blade holder includes a generally cylindrical core cutter, said at least one radial slot and said at least one slit being formed in a base plate of said blade holder.

16. The rotary knife fixture of claim 13 wherein said blade holder has a generally circular shape in includes an axially projecting tab formed near the periphery thereof for mating driven engagement within a notch formed in said means for rotatably driving said blade holder.

17. The rotary knife fixture of claim 13 wherein said blade holder has a shallow recess formed therein generally at an upstream side thereof, said at least one slab blade having a size and shape for seated reception within said shallow recess.

18. The rotary knife fixture of claim 17 wherein said at least one slit formed in said blade holder comprises a pair of said slits formed in radially spaced relation, and further wherein said at least one strip blade comprises a pair of said strip blades interconnected by a base piece to form a generally U-shaped construction with said pair of strip blades being receivable through said pair of slits, and further wherein said blade holder further comprises at least one shallow seat formed therein at opposite ends of said pair of slits for seated reception of said base piece.

19. The rotary knife fixture of claim 18 wherein said pair of slits formed in said blade holder comprises multiple pairs of said slits, each of said pair of said slits being separated by a shallow seat for seated reception of one of said base pieces interconnecting a pair of said strip blades.

20. The rotary knife fixture of claim 13 wherein said clamp plate comprises an arcuate segment secured to said blade holder by at least one clamp screw.

21. The rotary knife fixture of claim 13 wherein said blade holder further comprises at least axial one flow opening formed therein for through passage of water.

22. The rotary knife fixture of claim 13 wherein the vegetable products comprise potatoes.

23. A system for cutting potatoes into spiral loops, comprising:
hydraulic means for propelling potatoes one at a time through a flow conduit into cutting engagement with a knife fixture;
said knife fixture comprising a generally spiral-shaped blade holder mounted generally at the end of said flow conduit and having at least one radial slot formed therein between axially spaced upstream and downstream ends thereof, and at least one slit formed in said blade holder to extend generally perpendicular to said at least one radial slot;
said knife fixture further comprising at least one strip blade mounted onto said blade holder and extending through said at least one slit, at least one slab blade mounted onto said blade holder over said strip blade and having a radially extending cutting edge exposed at said at least one radial slot at said upstream end thereof, and a clamp plate mounted onto said blade holder over said at least one slab blade for clamping said at least one slab blade and said at least one strip blade removably onto said blade holder; and
means for rotatably driving said blade holder with said at least one slab blade and said at least one strip blade mounted thereon;
whereby said at least one slab blade cuts the vegetable products into generally spiral loops and said at least one strip blade cuts said spiral loops into elongated spiral strips of different diametric sizes; and
further whereby said at least one slab blade and said at least one strip blade are removable from said blade holder for sharpening.

24. The rotary knife fixture of claim 23 wherein said at least one slit formed in said blade holder comprises a pair of said slits formed in radially spaced relation, and further wherein said at least one strip blade comprises a pair of said strip blades interconnected by a base piece to form a generally U-shaped construction with said pair of strip blades being receivable through said pair of slits.

25. The rotary knife fixture of claim 23 wherein said blade holder includes a generally cylindrical core cutter, said at least one radial slot and said at least one slit being formed in a base plate of said blade holder.

26. The rotary knife fixture of claim 23 wherein said blade holder has a shallow recess formed therein generally at an upstream side thereof, said at least one slab blade having a size and shape for seated reception within said shallow recess.

27. The rotary knife fixture of claim 26 wherein said at least one slit formed in said blade holder comprises a pair of said slits formed in radially spaced relation, and further wherein said at least one strip blade comprises a pair of said strip blades interconnected by a base piece to form a generally U-shaped construction with said pair of strip blades being receivable through said pair of slits, and further wherein said blade holder further comprises at least one shallow seat formed therein at opposite ends of said pair of slits for seated reception of said base piece.

28. The rotary knife holder of claim 23 wherein said clamp plate comprises an arcuate segment secured to said blade holder by at least one clamp screw.

29. The rotary knife holder of claim 23 wherein said blade holder further comprises at least axial one flow opening formed therein for through passage of water.
